(19) United States
(12) Patent Application Publication
(10) Pub. No.: US 2025/0110851 A1
(43) Pub. Date: Apr. 3, 2025

(54) SYSTEM AND METHODS FOR EVENT DRIVEN ARCHITECTURE

(71) Applicant: Fidelity Information Services, LLC, Jacksonville, FL (US)

(72) Inventors: Ranadhir GHOSH, St Johns, FL (US); Ross P. ELLISON, West Windsor, NJ (US); John C. PLATAIS, Menomonee Falls, WI (US)

(21) Appl. No.: 18/960,790

(22) Filed: Nov. 26, 2024

Related U.S. Application Data
(63) Continuation-in-part of application No. 18/478,106, filed on Sep. 29, 2023.

(51) Int. Cl. G06F 11/36

(52) U.S. Cl. CPC G06F 11/3608

(57) ABSTRACT

A method for processing live streaming data includes creating matrix profiles for one or more parameters of a system including: identifying a set of subsequences from a stream of data, computing a distance profile for each subsequence of the set of subsequences, identifying a minimum calculated distance for each subsequence, and determining a matrix profile that includes one or more minimum calculated distances for each subsequence from the set of subsequences, identifying a first state for a first interval of the stream of data based on a comparison of the one or more minimum calculated distances from the matrix profile being below a threshold value over a span of time, and identifying a second state for a second interval of the stream of data based on a comparison of the one or more minimum calculated distances from the matrix profile being above the threshold value over a span of time.

### CROSS-REFERENCE TO RELATED APPLICATION(S)

This patent application is a continuation-in-part of and claims the benefit of priority to U.S. application Ser. No. 18/478,106, filed on Sep. 29, 2023, the entirety of which is incorporated herein by reference.

### TECHNICAL FIELD

Various embodiments of the present disclosure relate generally to information technology (IT) management systems and, more particularly, to systems and methods for dynamic change point and anomaly detection.

### BACKGROUND

In computing systems, for example computing systems that perform financial services and electronic payment transactions, programing changes may occur. For example, software may be updated. Changes in the system may lead to incidents, defects, issues, bugs or problems (collectively referred to as incidents) within the system. These incidents may occur at the time of a software change or at a later time. These incidents may be costly for the company as users may not be able to use the services and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company.

In a data pipeline it may be difficult for a system to analyze ever-changing data streams or frequencies and determine what is considered anomalous at a group and granular level. The present disclosure is directed to addressing this and other drawbacks to the existing computing system analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer-implemented method for processing live streaming data, the method including: creating, for a stream of data, a matrix profile from one or more parameters of a system, the creating including: identifying a set of subsequences from the stream of data; computing a distance profile for each subsequence of the set of subsequences, wherein the distance profile includes a calculated distance between a particular subsequence and each other subsequence of the set of subsequences; identifying a minimum calculated distance for each subsequence from the set of subsequences; and determining a matrix profile that includes one or more minimum calculated distances for each subsequence from the set of subsequences, the matrix profile being a vector; identifying a first state for a first interval of the stream of data based on a comparison of the one or more minimum calculated distances from the matrix profile being below a threshold value over a span of time; and identifying a second state for a second interval of the stream of data based on a comparison of the one or more minimum calculated distances from the matrix profile being above the threshold value over a span of time.

In some aspects, the techniques described herein relate to a method, further including identifying one or more potential discords in the stream of data based on values of one or more of the matrix profiles being above a first threshold value, wherein the first state is a state indicating that the system is functioning between predetermined upper and lower bounds for the one or more parameters based on the values of the matrix profile being below the threshold value over a first span of time.

In some aspects, the techniques described herein relate to a method, further including identifying one or more potential discords in the stream of data based on values of one or more of the matrix profiles being above a first threshold value, wherein the second state is a state indicating that the system requires further investigation for the one or more parameters based on the values of the matrix profile being above the threshold value over a second span of time.

In some aspects, the techniques described herein relate to a method, further including identifying one or more potential discords in the stream of data based on values of one or more of the matrix profiles being above a first threshold value, wherein the second state is a state indicating that the system requires intervention for the one or more parameters based on the values of the matrix profile being above the threshold value over a second span of time.

In some aspects, the techniques described herein relate to a method, further including: processing the stream of data from one or more devices using a real time anomaly streaming module by producing a stream of granular data based on the one or more parameters from the one or more devices, wherein the data is a time series of data.

In some aspects, the techniques described herein relate to a method, wherein the one or more parameters of the system includes central processing unit load.

In some aspects, the techniques described herein relate to a method, wherein the one or more parameters of the system includes percent input output wait.

In some aspects, the techniques described herein relate to a method, wherein the one or more parameters of the system includes percent central processing unit utilization.

In some aspects, the techniques described herein relate to a method, wherein the one or more parameters of the system includes percent memory utilization.

In some aspects, the techniques described herein relate to a method, wherein the one or more parameters of the system includes percent free swap.

In some aspects, the techniques described herein relate to a method, wherein at least one of the identifying the first state or the identifying the second state further includes processing live streaming data for thousands of systems simultaneously.

In some aspects, the techniques described herein relate to a method, further including utilizing a sliding window approach to extract all possible subsequences of a particular length from the stream of data to create the matrix profile.

In some aspects, the techniques described herein relate to a method, wherein the calculated distance between the particular subsequence and each other subsequences from the set of subsequences includes applying a Euclidean distance calculation to create the matrix profile.

In some aspects, the techniques described herein relate to a computer-implemented method for processing live streaming data, the method including: monitoring data from a computer device using a programming interface with a unified stream-processing framework, wherein the data corresponds to one or more parameters of the computer device; creating a matrix profile for the data; identifying a healthy state based on a first threshold value of the matrix profile over a span of time; identifying an investigation state based on a second threshold value of the matrix profile over the span of time; identifying an intervention state based on a third threshold value of the matrix profile over the span of time; and outputting an alert based on the identifying of the investigation state or the identifying of the intervention state.

In some aspects, the techniques described herein relate to a method, wherein the one or more parameters of the computer device includes central processing unit load.

In some aspects, the techniques described herein relate to a method, wherein the one or more parameters of the computer device includes percent input output wait.

In some aspects, the techniques described herein relate to a method, wherein the one or more parameters of the computer device includes percent central processing unit utilization.

In some aspects, the techniques described herein relate to a method, wherein the one or more parameters of the computer device includes percent memory utilization.

In some aspects, the techniques described herein relate to a method, wherein the one or more parameters of the computer device includes percent free swap.

In some aspects, the techniques described herein relate to a system for determining group-level anomalies for information technology events, the system including: a memory having processor-readable instructions stored therein; and at least one processor configured to access the memory and execute the processor-readable instructions to perform operations including: creating for a stream of data, a matrix profile from one or more parameters of a system, the creating including: identifying a set of subsequences from the stream of data; computing a distance profile for each subsequence of the set of subsequences, wherein the distance profile includes a calculated distance between a particular subsequence and each other subsequence of the set of subsequences; identifying a minimum calculated distance for each subsequence from the set of subsequences; and determining a matrix profile that includes one or more minimum calculated distances for each subsequence from the set of subsequences, the matrix profile being a vector; identifying a first state for a first interval of the stream of data based on a comparison of the one or more minimum calculated distances from the matrix profile being below a threshold value over a span of time; and identifying a second state for a second interval of the stream of data based on a comparison of the one or more minimum calculated distances from the matrix profile being above the threshold value over a span of time.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that multiple parties may fully utilize their data without allowing others to have direct access to raw data. The disclosed systems and methods discussed below may allow advertisers to understand users' online behaviors through the indirect use of raw data and may maintain privacy of the users and the data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system overview for a data pipeline for an artificial intelligence module to predict and troubleshoot incidents in a system, according to one or more embodiments.

FIG. 2 depicts a flowchart for a process of real-time stream data processing, according to one or more embodiments.

FIG. 3 illustrates a computer system for executing the techniques described herein, according to one or more embodiments of the present disclosure.

FIG. 4 depicts graphs of CPU load and matrix profile implemented by the system herein, according to one or more embodiments.

FIG. 5 depicts graphs of CPU load and matrix profile implemented by the system herein, according to one or more embodiments.

FIG. 6 depicts graphs of CPU load and matrix profile implemented by the system herein, according to one or more embodiments.

FIG. 7 depicts graphs of percent I/O wait and matrix profile implemented by the system herein, according to one or more embodiments.

FIG. 8 depicts graphs of percent I/O wait and matrix profile implemented by the system herein, according to one or more embodiments.

FIG. 9 depicts graphs of percent CPU utilization and matrix profile implemented by the system herein, according to one or more embodiments.

FIG. 10 depicts graphs of percent CPU utilization and matrix profile implemented by the system herein, according to one or more embodiments.

FIG. 11 depicts graphs of percent memory utilization and matrix profile implemented by the system herein, according to one or more embodiments.

FIG. 12 depicts graphs of percent memory utilization and matrix profile implemented by the system herein, according to one or more embodiments.

FIG. 13 depicts graphs of percent free swap and matrix profile implemented by the system herein, according to one or more embodiments.

FIG. 14 depicts graphs of percent free swap and matrix profile implemented by the system herein, according to one or more embodiments.

FIG. 15 depicts graphs of percent free swap and matrix profile implemented by the system herein, according to one or more embodiments.

### DETAILED DESCRIPTION OF EMBODIMENTS

Various embodiments of the present disclosure relate generally to enabling voice control of an interactive audiovisual environment, and monitoring user behavior to assess engagement.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

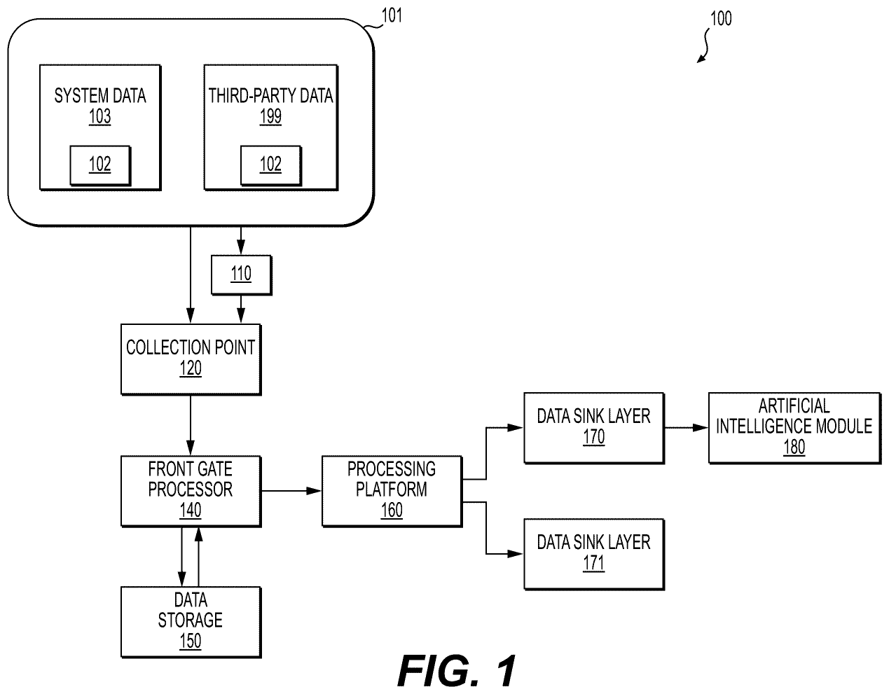

Any suitable system infrastructure may be put into place to allow user control of an interactive audiovisual environment, and engagement assessment. FIG. 1 and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 1. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Many organizations including enterprise corporations have extensive infrastructure. Much of this infrastructure may consist of their computer devices and computer systems. An organization may succeed or fail depending on the performance of their computers or systems. Whether the company is in the software as a service (SAAS), financial technology (FinTech), or healthcare, the ability for a company to do business may rely on their ability to have their computer infrastructure run properly.

It is common for many organizations to have well over a million computers that help run the business. Some organizations may have hundreds or thousands of computers or systems as a part of their infrastructure. Whether the computer is reading a credit card reader at a supermarket, or part of a datacenter storing financial information, a company may need to know if the computer is working well, and if the computer or system is not working well, in addition to what the exact problem is to fix the computer or system not working well.

Manually monitoring such a large number of computers or systems may not a viable solution. The vast quantity of computer data and other data coming from hundreds, thousands, or even millions of computers may need to be monitored virtually. However monitoring computers virtually may itself pose difficulties, and monitoring such a large number of computers or machines may be a science of its own. Within each computer there may be many working components, including the central processing unit (CPU), random-access memory (RAM), and Disk, each which may include many sub variables and metrics. A computer or system may not explicitly say what is wrong with it or indicate to a user if there is a problem.

One or more embodiments may provide a novel method for a large enterprise corporation or organization to simultaneously monitor every single computer and variable within the computer or system to instantly or near-instantly detect any anomalies or possible problems. This may meet unmet market needs of being able to detect a problem before it occurs and causes damage, as well as prevent future failures. One or more embodiments may provide unique solution that may be deployed horizontally across the entire infrastructure of a corporation or organization.

One or more embodiments may provide an anomaly detection algorithm including matrix profiling. Matrix profiles may involve computing a distance profile of each subsequence within a time series then combining these distance profiles into a matrix profile, which may also be a vector that stores the minimum distance of each subsequence to all others. A small distance from one profile to another may indicate that this profile (or one similar to it) has been seen before, a large distance from one profile to another may indicate that it has no profile very similar to it anywhere else in the time series.

One or more embodiments may include a computer-implemented method for processing live streaming data, the method comprising creating, for a stream of data, a matrix profile from one or more parameters of a system, the creating including computing a distance profile of each subsequence within the stream of data, computing a minimum distance of each subsequence to all other subsequences into the matrix profile, and combining these distance profiles into the matrix profile that is a vector, identifying potential discords based on values of granular data from the stream of data above or below a first threshold, identifying a first state based on a comparison of the potential discords and values of the matrix profile below a second threshold value, and identifying a second state based on a comparison of the potential discords and the values of the matrix profile above the second threshold value. One or more embodiments may provide a first state which may be a state that indicates the system is functioning between predetermined upper and lower bounds for one or more parameters based on a comparison of one or more potential discords in a stream of data and values of the matrix profile using the second threshold value. Predetermined upper or lower bounds may include default values, user specified values, or system specific values. One or more embodiments may provide identifying one or more potential discords in the stream of data based on values of one or more of the matrix profiles and granular data from the stream of data being above a first threshold value. One or more embodiments may provide identifying one or more potential discords in the stream of data based on values of one or more of the matrix profiles from the stream of data being above a first threshold value over a first span of time. One or more embodiments may provide identifying a first state for a first interval of the stream of data based on a comparison of the one or more minimum calculated distances from the matrix profile being below a second threshold value over a second span of time, and identifying a second state for a second interval of the stream of data based on a comparison of the one or more potential discords and the one or more minimum calculated distances from the matrix profile being above the second threshold value over a third span of time. One or more embodiments may provide the first span of time may be the same as the second span of time which may be the same as the third span of time. One or more embodiments may provide the first span of time may be the same as the third span of time. Furthermore, regarding subsequences, one or more embodiments may provide that subsequences can be an assigned length, and the set of subsequences can be for a particular set of time to create the matrix profile.

One or more embodiments may provide, a computer-implemented method for processing live streaming data, the method comprising monitoring data from a computer device using a programming interface with a unified stream-processing framework (e.g., PyFlink), wherein the data corresponds to one or more parameters of the computer device (the parameters including, for example, any aspect or component of a computer or system that can be monitored), creating a matrix profile for the data, identifying a healthy state based on a first threshold value of the matrix profile over a span of time, identifying an investigation state based on a second threshold value of the matrix profile over a span of time, identifying an intervention state based on a third threshold value of the matrix profile over a span of time, and outputting an alert based on the identifying of the investigation state or the identifying of the intervention state. One or more embodiments may provide not outputting an alert based on identification of an investigation state or an intervention state, but instead prompting a user or system in some other way. A span of time may include a user specified value or a system designated value. A span of time may include a value that may include a range of values in microseconds, seconds, minutes, hours, or days. A span of time may be a non-zero value.

One or more embodiments may provide a process that can take place on multiple servers at once. For example, one or more embodiments may provide a process that takes place for hundreds of thousands of servers, devices, or systems at the same time. One or more embodiments may provide a process or processing that takes place for thousands of servers simultaneously or near-simultaneously in real-time or near-real-time.

One or more embodiments may provide monitoring data from a computer device using a programming interface with a unified stream-processing framework, which may be PyFlink, and include data which may correspond to one or more parameters of a computer device or system, which may include CPU utilization, CPU load, percent memory utilization, percent input output wait, and percent free swap. One or more embodiments may provide creating a matrix profile for the data, identifying a healthy state based on a first threshold value of the matrix profile and a first threshold value of the data, identifying an investigation state based on a second threshold value of the matrix profile and a second threshold value of the data, identifying an intervention state based on a third threshold value of the matrix profile and a third threshold value of the data, and outputting an alert based on the identifying of the investigation state or the identifying of the intervention state. Granular data may include data that is a subset of data received from a computer device or system or may include all data received from a computer device or system. For example, a time series of live streamed data received from a computer may include within it as a subset CPU utilization, CPU load, percent memory utilization, percent input output wait, and percent free swap.

A discord may be an anomalous subsequence and can include the subsequence of a given length that has the largest z-normalized Euclidean distance to its closest match. The length of the subsequence may be determined by some prior knowledge on the time series. A discord may be a time series discord which may be a subsequence that is most dissimilar to its nearest neighbor, also known as the most top discord or most significant discord. A discord may represent an anomaly in a stream data at a single computer device's unique parameter level. The systems and methods described herein may be configured to identify discords in real time for a particular computer for one or more parameters.

One or more matrix profiles may include calculation of distance profiles from a subsequence. A subsequence may be a contiguous segment or subset of data points extracted from a larger time series or sequence. The individual subsequence may be analyzed separately or distinctly from the entire set of data. A subsequence may include being determined based on a set time interval, or being determined based on a set amount of data received.

One or more embodiments may provide a sliding window approach utilized to extract all possible subsequences of a particular length from a data stream. One or more embodiments may provide a tumbling window approach. One or more embodiments may provide a system including a memory having processor-readable instructions stored therein and at least one processor configured to access the memory and execute the processor-readable instructions to perform operations including creating for a stream of data, a matrix profile from one or more parameters of a system as described herein.

One or more embodiments may provide for implementation including monitoring data from a computer device using a programming interface with a unified stream-processing framework, for example using PyFlink. One or more embodiments may provide use of a programming interface with a unified stream-processing framework (for example, PyFlink) as a real time anomaly streaming module for very fine grain data at the single computer device's unique parameter's level. Very fine grain data at the single computer device's unique parameter's level may include data from sources provided herein, and also may include data from other computer device unique parameters.

One or more benefits or advantages of the systems or methods described herein may include a system or method which lowers an amount of false positive detection as compared to conventional systems. One or more benefits or advantages of the systems or methods described herein may include using matrix profiles for anomaly detection deployed across thousands of machines monitoring each metric, which may allow large organizations with vast infrastructure to reliably and scientifically understand points of failure, weaknesses, and room for improvement in their computer systems. For example, one or more benefits or advantages of the systems or methods described herein may include that waiting for a computer to fail and then sending someone to go out and fix it will become much less likely. The matrix profile may detect a shift in any of the possible metrics that can determine a computer's failure thus once one or more parameters strays from its normal pattern it can be detected and recognized. Old technology relied on waiting for a computer system to fail and then manually read the logs to see the point of failure, which may have included attempts to fix and reboot the machine and hope that it does not occur again. The systems or methods described herein may provide a solution which uses each single machine's historical data to allow a comparison with its current data, and may allow indication of what may have caused it to fail, or what may cause it to fail in the future. One or more embodiments may provide an infrastructure that proactively monitors, searches specific servers, and views every fine detail of one or more parameters of many different machines, and may include investigation of potential problems, or intervention in case of a degraded machine.

Current technology may simply send out an alert for each parameter. For example, this may include an alert that “Percent CPU Utilization has reached 100%.” While this may be a cause for a concern, many computer systems daily hit 100% and follow a seasonal pattern and it likely that it may not be a concern. This may lead to repetitive non-useful alerts, and may lead alerts to become unread. One or more benefits or advantages of the systems or methods described herein may include matrix profiles that may look at past historical data and may see the exact system's history and may recognize that hitting 100% CPU Utilization is normal, and may even be expected. Old technology of alerts based on other computer's behavior may no longer be needed, and personalized anomaly detection for each and every computer system may increase organizational efficiency, reduce labor costs of staff relating to anomalies, reduce costs for IT infrastructure, or IT infrastructure maintenance. One or more benefits or advantages of the systems or methods described herein may include reliable creation of a by-device-unique history for each of the computer's parameters and may allow for the detection of any anomalous patterns or parameters. One or more benefits or advantages of the systems or methods described herein may include avoiding the pitfalls of current technology's standard alerting system and surpassing old technology of checking the data after the computer has already failed.

FIG. 1 depicts an exemplary system overview for a data pipeline for an artificial intelligence module to predict and troubleshoot incidents in a system, according to one or more embodiments. For example, the data pipeline system 100 may aggregate and send incident data to an artificial intelligence module 180, wherein the artificial intelligence module 180 is configured to aggregate and map incident characteristics into daily incident proles using feature engineering and/or multiple level clustering. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and the artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may for example be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may for example be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may for example be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to the files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., data sink layer 170 and/or data sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., data sink layer 170 and data sink layer 171). Incident data 102 processed from processing platform 160 may be transmitted to and stored in data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to the artificial intelligence module 180. The data sink layers may be data lakes, data warehouses, or cloud storage systems. Each data sink layer may be configured to store incident data 102 in both a structured or unstructured format. Data sink layer 170 may store incident data 102 with several different formats. For example, data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster). Further processing may thus be performed prior to the processed data being received by the artificial intelligence module 180.

As discussed, the data pipeline system 100 may include the artificial intelligence module 180. The artificial intelligence module 180 may include a machine-learning component. The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

The system (e.g., data pipeline system 100) described herein may provide real-time stream data processing and anomaly detection. The system may apply real time decision making. Real-time stream processing may allow for immediate decision making based on the most recent data. The system may continuously learn. Stream processing may support a system configured to learn and adapt continuously. For example, models may be updated as new data comes in. The system may be configured to update as new data is received. The system may be cost efficient. Stream processing may better reduce computing, and handle dynamic hanging data without costly crashes. The system may handle unstructured data. Stream processing may be better equipped to handle unstructured data as compared to batch data. The system may be configured to handle different types of anomalies. Not every spike in data may be considered an anomaly. Not properly categorizing anomalies may be expensive and cost recourses. Accurately finding anomalies in data may depend on the type of data and algorithm applied.

The system described herein may for example utilize the processing platform 160. For example, the processing platform may utilize PyFlink for stream data processing. The processing objective may be to find anomalous patterns in data that need real time addressing. The system may be configured to receive thousands of data sources and thousands of different patterns, and the system be configured to find anomalies in real time.

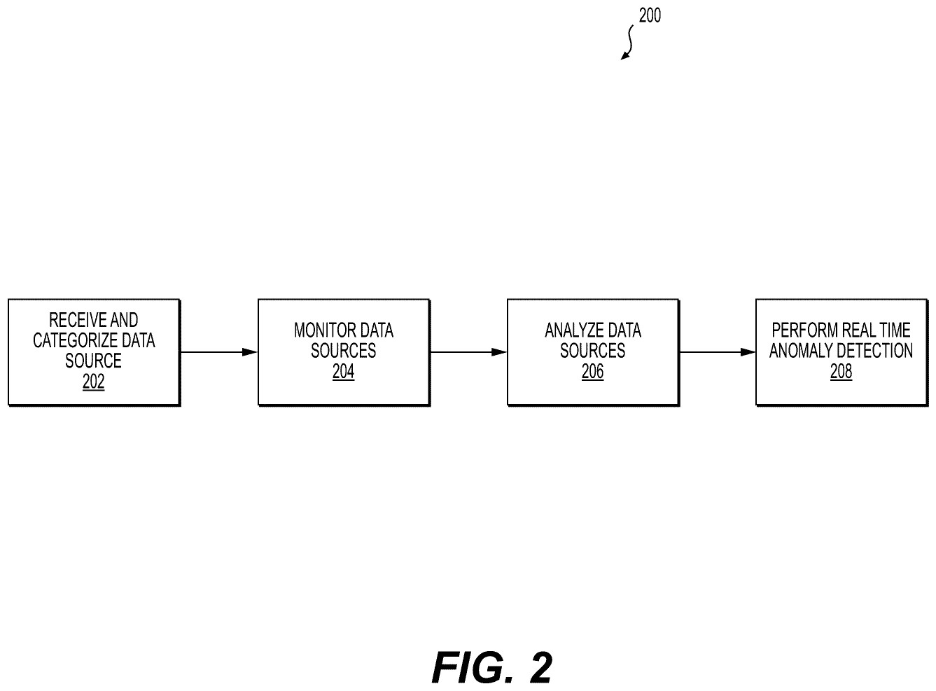

FIG. 2 depicts a flowchart for a process of real-time stream data processing, according to one or more embodiments.

As depicted in flowchart for a process 200, at step 202, the system may for example receive as input individual data sources. For example, the system may be configured to receive hundreds of thousands of individual data sources. The system may be configured to receive greater or fewer than hundreds of thousands of individual data sources. Further, the system may categorize the data sources into a group for common processing. At step 204, the system described herein may monitor the data sources individually and as a group, utilizing the techniques described herein. The system may monitor each data source as part of a group in a framework or a distributed processing engine for stateful computations over unbounded and bounded data streams. The system may include implementation with a Python API for Apache Flink such as PyFlink utilizing the techniques described herein. At step 206, the system described herein may analyze, in real time, data sources and groupings of data. At step 208, the system may apply real time anomaly detection of the individual and group level data sources utilizing the techniques described herein.

The system may for example utilize two techniques in stream-data processing: windowing for group-level anomaly detection and matrix profile for individual data source anomaly detection. Both techniques may be implemented by the processing platform 160.

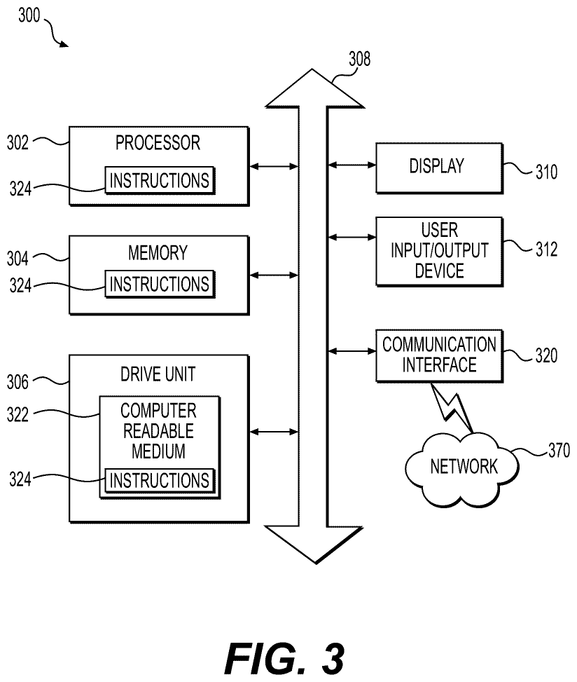

FIG. 3 illustrates a computer system for executing the techniques described herein, according to one or more embodiments of the present disclosure.

As illustrated in FIG. 3, the computer system 300 may include a processor 302, e.g., a central processing unit (CPU), a graphics processing unit (GPU), or both. The processor 302 may be a component in a variety of systems. For example, the processor 302 may be part of a standard personal computer or a workstation. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The computer system 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the programmed processor 302 executing the instructions stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the computer system 300 may include an input device 312 configured to allow a user to interact with any of the components of computer system 300. The input device 312 may be a number pad, a keyboard, or a cursor control device, such as a mouse, or a joystick, touch screen display, remote control, or any other device operative to interact with the computer system 300.

The computer system 300 may also or alternatively include a disk drive unit, optical drive unit, or drive unit 306. The drive unit 306 may include a computer-readable medium 322 in which one or more sets of instructions 324, e.g., software, can be embedded. Further, the instructions 324 may embody one or more of the methods or logic as described herein. The instructions 324 may reside completely or partially within the memory 304 and/or within the processor 302 during execution by the computer system 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication interface 320, and/or using a bus 308. Communication interface 320 (which may be a communication port or interface) may be a part of the processor 302 or may be a separate component. The communication interface 320 may be created in software or may be a physical connection in hardware. The communication interface 320 may be configured to connect with a network 370, external media, the display 310, or any other components in computer system 300, or combinations thereof. The connection with the network 370 may be a physical connection, such as a wired Ethernet connection or may be established wirelessly as discussed below. Likewise, the additional connections with other components of the computer system 300 may be physical connections or may be established wirelessly. The network 370 may alternatively be directly connected to the bus 308.

While the computer-readable medium 322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 300 may be connected to one or more networks, which may include network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

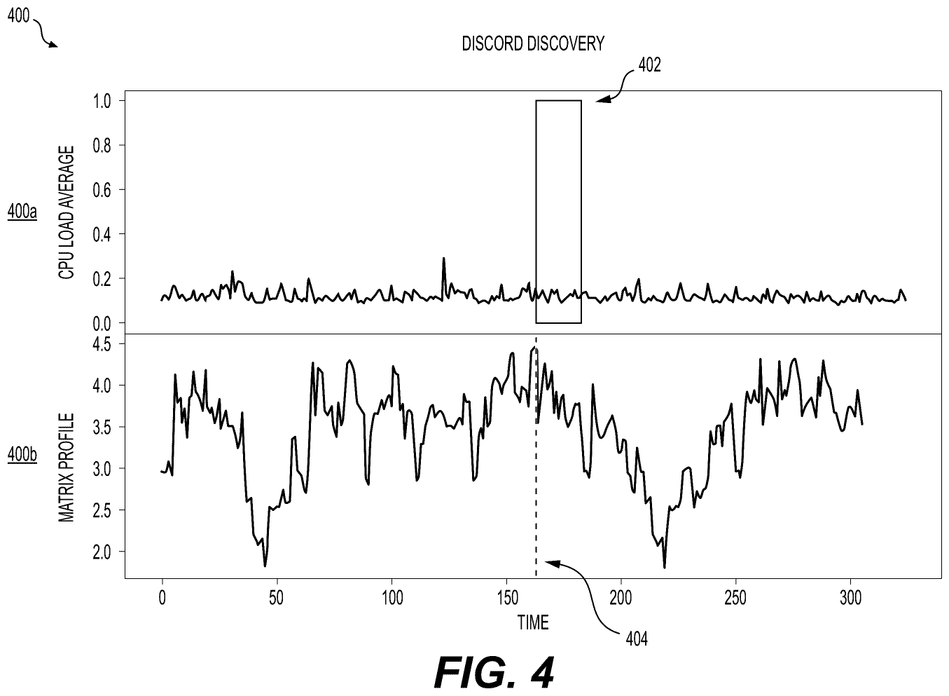

FIG. 4 depicts graphs of CPU load and matrix profile implemented by the system herein, according to one or more embodiments. Discord discovery window 400 may include graph 400a, matrix profile 400b, indication 402, and indication 404. Graph 400a may depict CPU load average for one or more computers. Matrix profile 400b may be the corresponding matrix profile for graph 400a or for one or more computers. Indication 402 may indicate a portion of graph 400a. Indication 404 may indicate a portion of matrix profile 400b. Each time unit of graph 400a or matrix profile 400b may be one hour.

Discord discovery window 400 may indicate a healthy CPU load. CPU load or central processing unit load may include the number of processes in queue waiting to be run. A high number may indicate there are many processes in queue waiting and the CPU cannot handle its load. A low number may indicate that the processes are generally run in a timely manner. Discord discovery window 400 may indicate a computer with a light load. This may signify processes are all being run without having to wait in a queue to be run. The matrix profile 400b may indicate there are no prominent subsequences that stand out which we can confirm visually as well. Discord discovery window 400 may indicate that a user monitoring for serious alerts or anomalies has no reason to suspect that this system is anomalous.

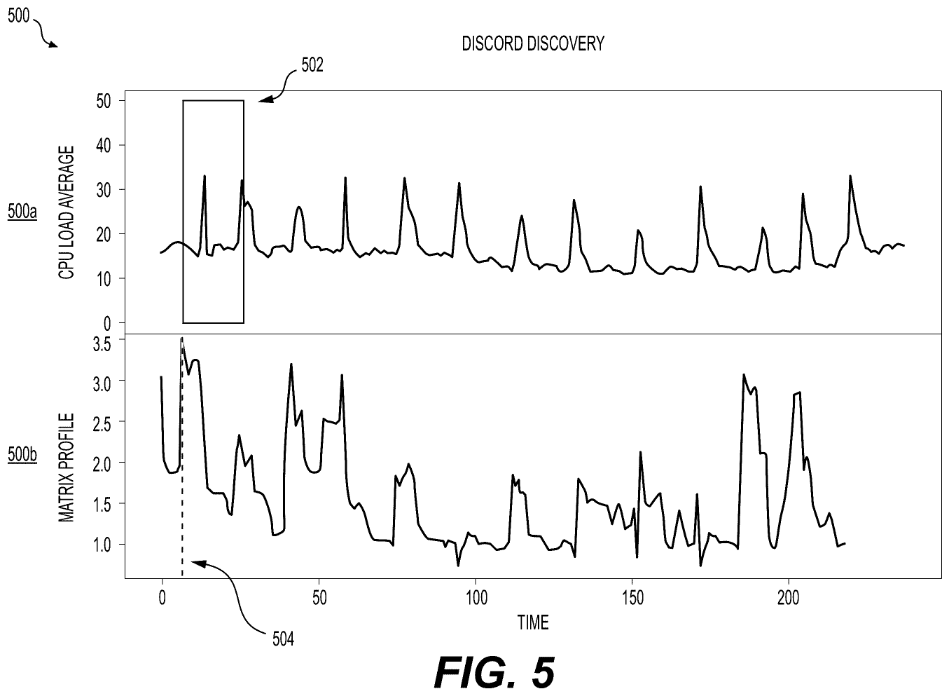

FIG. 5 depicts graphs of CPU load and matrix profile implemented by the system herein, according to one or more embodiments. Discord discovery window 500 may include graph 500a, matrix profile 500b, indication 502, and indication 504. Graph 500a may depict CPU load average for one or more computers. Matrix profile 500b may be the corresponding matrix profile for graph 500a or for one or more computers or subsystems. Indication 502 may indicate a portion of graph 500a. Indication 504 may indicate a portion of matrix profile 500b. Each time unit of graph 500a or matrix profile 500b may be one hour.

Discord discovery window 500 may indicate healthy CPU load that may warrant further scrutiny. Discord discovery window 500, matrix profile 500b, graph 500a, and indication 502 may indicate this computer's CPU consistently has an average load of 15+ processes and follows a daily spike. Indication 504 and matrix profile 500b may indicate that none of the matrix profile values are significantly peaked higher than any others, which may be confirmed visually. Although indication 502 and graph 500a may indicate the load is above zero, the matrix profile 500b and indication 504 may confirm that this is a seasonal-daily expected behavior and may be normal for this machine.

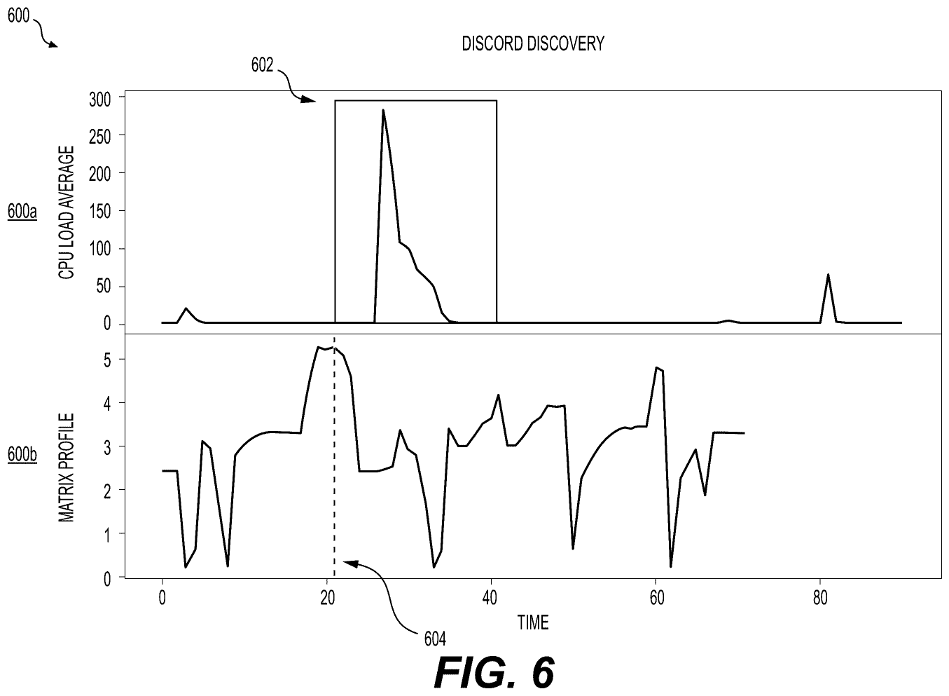

FIG. 6 depicts graphs of CPU load and matrix profile implemented by the system herein, according to one or more embodiments.

Discord discovery window 600 may include graph 600a, matrix profile 600b, indication 602, and indication 604. Graph 600a may depict CPU load average for one or more computers. Matrix profile 600b may be the corresponding matrix profile for graph 600a or for one or more computers or subsystems. Indication 602 may indicate a portion of graph 600a. Indication 604 may indicate a portion of matrix profile 600b. Each time unit of graph 600a or matrix profile 600b may be one hour.

Discord discovery window 600 may indicate matrix profiling indicating a CPU load that warrants further investigation. Indication 602 may indicate a strong example of a prominent peak of the matrix profile value which detected an anomaly in the CPU Load. Visually at indication 602 a user or system may see a significant lasting spike that is never repeated elsewhere in the sequence, coupled with a large matrix profile value which may be seen at indication 604, this may indicate that computer warrants further investigation.

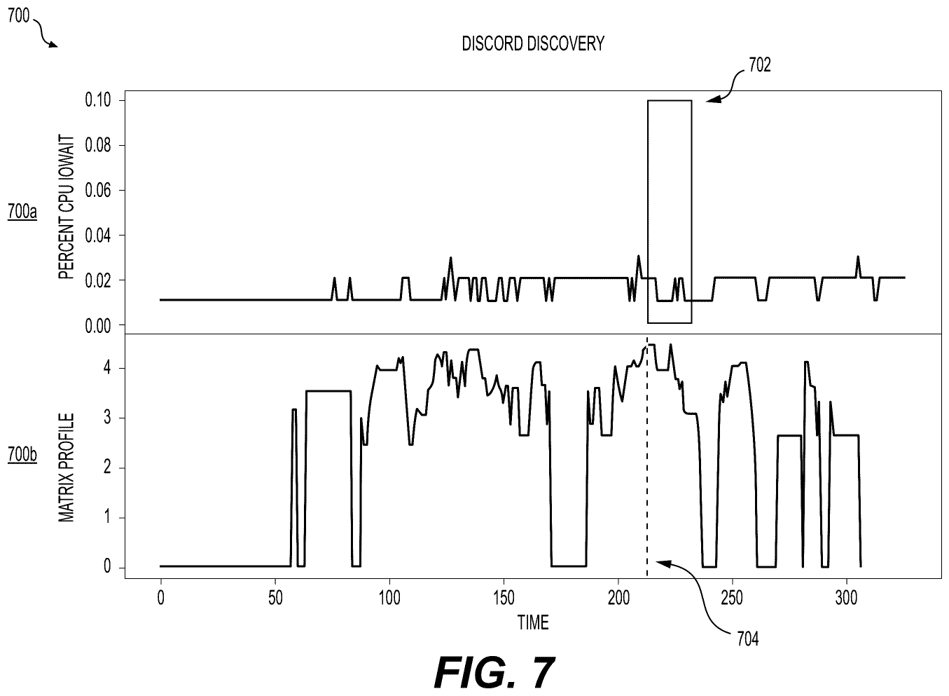

FIG. 7 depicts graphs of percent I/O wait and matrix profile implemented by the system herein, according to one or more embodiments.

Discord discovery window 700 may include graph 700a, matrix profile 700b, indication 702, and indication 704. Graph 700a may depict percent I/O wait for one or more computers, which may be the percentage of time a CPU is idle while waiting for a disk I/O request to complete. Matrix profile 700b may be the corresponding matrix profile for graph 700a or for one or more computers or subsystems. Indication 702 may indicate a portion of graph 700a. Indication 704 may indicate a portion of matrix profile 700b. Each time unit of graph 700a or matrix profile 700b may be a time unit corresponding to seconds, minutes, hours, or days, which may depend on values presented or data collected.

Discord discovery window 700 may indicate a computer with a small percent IO Wait, which may be seen in graph 700a and by indication 702. Discord discovery window 700 may also indicate a healthy IO wait. This may signify the computer is almost never waiting on in/out (I/O) operations and may always be doing processing. The matrix profile 700b and corresponding indication 704 may indicate to a user or system that there are no prominent subsequences that stand out, which may be confirmed visually as well.

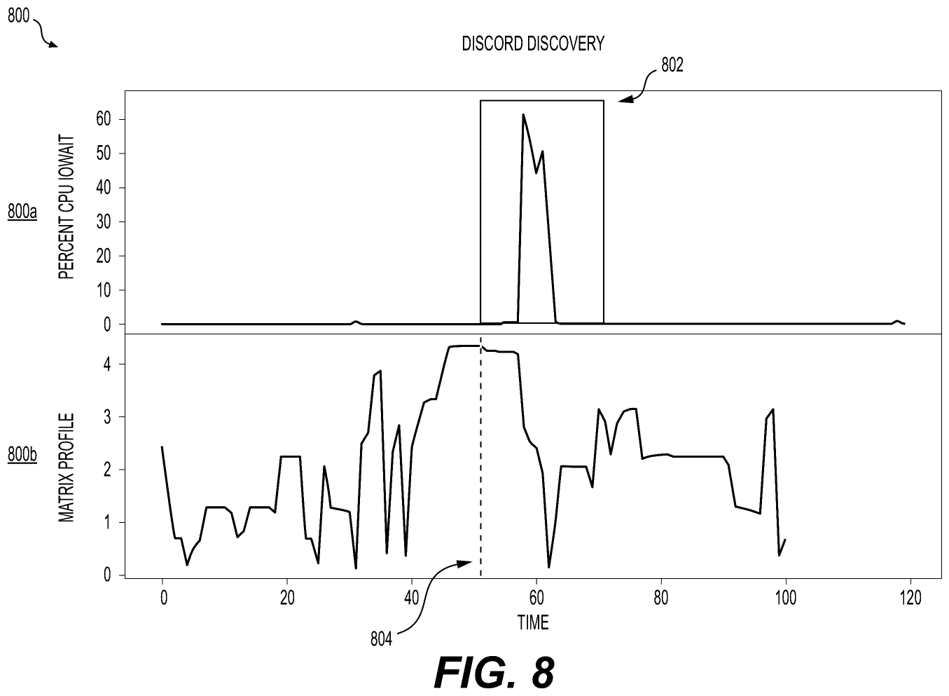

FIG. 8 depicts graphs of percent I/O wait and matrix profile implemented by the system herein, according to one or more embodiments.

Discord discovery window 800 may include graph 800a, matrix profile 800b, indication 802, and indication 804. Graph 800a may depict percent I/O wait for one or more computers, which may be the percentage of time a CPU is idle while waiting for a disk I/O request to complete, or which may be the percentage of time that the CPU is idle while waiting for pending disk I/O requests. Matrix profile 800b may be the corresponding matrix profile for graph 800a or for one or more computers or subsystems. Indication 802 may indicate a portion of graph 800a. Indication 804 may indicate a portion of matrix profile 800b. Each time unit of graph 800a or matrix profile 800b may be a time unit corresponding to seconds, minutes, hours, or days, which may depend on values presented or data collected.

Discord discovery window 800, graph 800a, and matrix profile 800b may indicate an instance where matrix profile 800b picks up or indicates an anomaly that warrants further investigation. For example, graph 800a may indicate an indicated by indication 802 and confirmed by indication 804.

In graph 800a a user or system may indicate or see a computer with a small percent IO Wait. At indication 802 and around time 50 a user or system may indicate a spike in IO Wait which may signify the computer is spending a significant amount of time waiting on in/out operations and not doing processing. The matrix profile 800b may show or indicate to a user or system that there are one or more prominent subsequences that stand out, which may be confirmed visually as well in both the IO Wait and the matrix profile. Discord discovery window 800, graph 800a, matrix profile 800b, indication 802, and indication 804 may resultantly indicate that a particular machine warrants further investigation as to what has caused the identified anomaly.

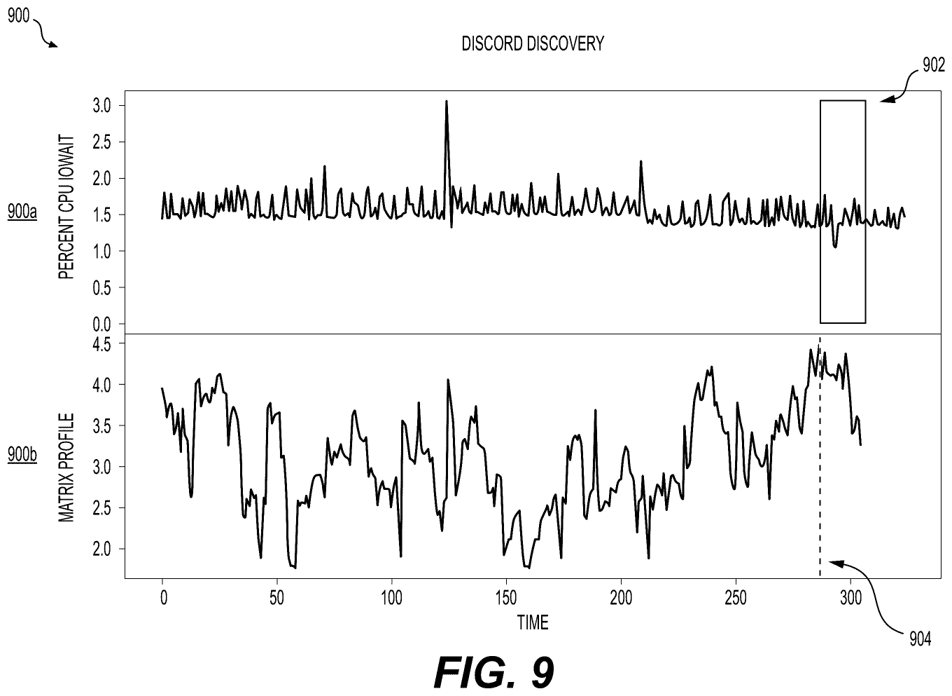

FIG. 9 depicts graphs of percent CPU utilization and matrix profile implemented by the system herein, according to one or more embodiments.

Discord discovery window 900 may include graph 900a, matrix profile 900b, indication 902, and indication 904. Graph 900a may depict percent CPU utilization for one or more computers, which may be the amount of work a CPU does to perform the tasks given to it. Matrix profile 900b may be the corresponding matrix profile for graph 900a or for one or more computers or subsystems. Indication 902 may indicate a portion of graph 900a. Indication 904 may indicate a portion of matrix profile 900b. Each time unit of graph 900a or matrix profile 900b may be a time unit corresponding to seconds, minutes, hours, or days, which may depend on values presented or data collected.

Discord discovery window 900 may indicate a computer with a small percent CPU Utilization, which may also be seen at indication 902. This may signify that the computer is never throttled or has any concerns about reaching processing capacity. The matrix profile 900b shows us there are no prominent subsequences that stand out which we can confirm visually as well. Discord discovery window 900, graph 900a, matrix profile 900b, indication 902, and indication 904 may indicate a computer or subsystem with healthy CPU utilization.

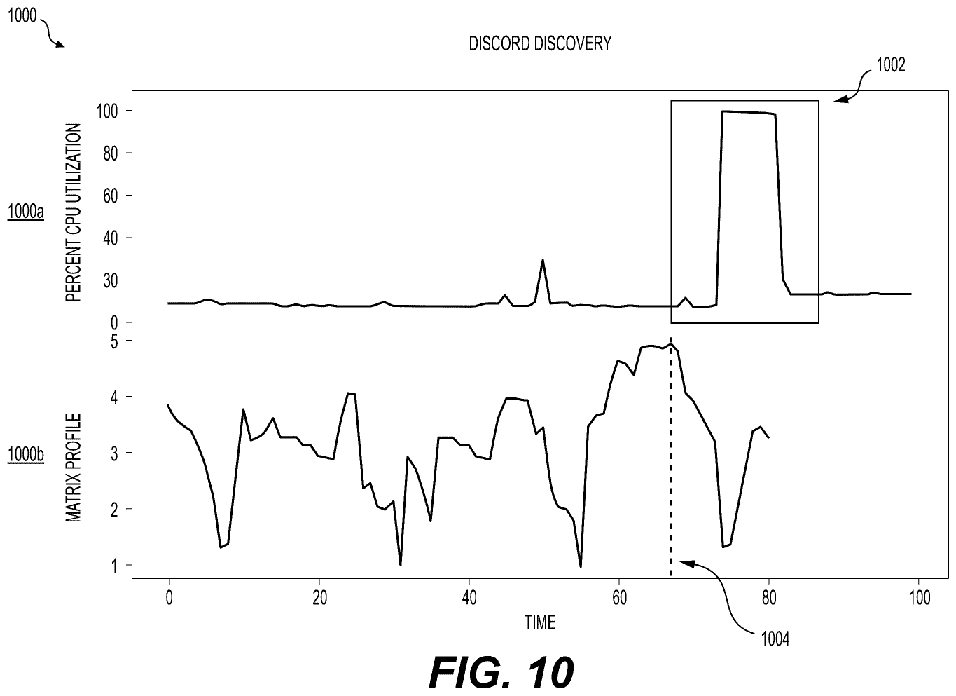

FIG. 10 depicts graphs of percent CPU utilization and matrix profile implemented by the system herein, according to one or more embodiments.

Discord discovery window 1000 may include graph 1000a, matrix profile 1000b, indication 1002, and indication 1004. Graph 1000a may depict percent CPU utilization for one or more computers, which may be the amount of work a CPU does to perform the tasks given to it. Matrix profile 1000b may be the corresponding matrix profile for graph 1000a or for one or more computers or subsystems. Indication 1002 may indicate a portion of graph 1000a. Indication 1004 may indicate a portion of matrix profile 1000b. Each time unit of graph 1000a or matrix profile 1000b may be a time unit corresponding to seconds, minutes, hours, or days, which may depend on values presented or data collected.

Discord discovery window 1000, graph 1000a, matrix profile 1000b, indication 1002, and indication 1004 may indicate a computer or subsystem where matrix profile 1000b picks up or indicates a CPU utilization percentage anomaly. For example, graph 1000a and indication 1002 may indicate a computer or subsystem with a large spike in percent CPU Utilization. At the time of indication 1004 or around time 70 a user or system may see the CPU Utilization spike to 100, resulting in a throttling of processing. The matrix profile 1000b may indicate to a user or system there are one or more prominent subsequences that stand out, which may be confirmed visually as well in both the percent CPU utilization indicated by graph 1000a and the matrix profile 1000b. Thus, discord discovery window 1000, graph 1000a, indication 1002, matrix profile 1000b, and indication 1004 may indicate or signify that this computer or subsystem warrants further investigation.

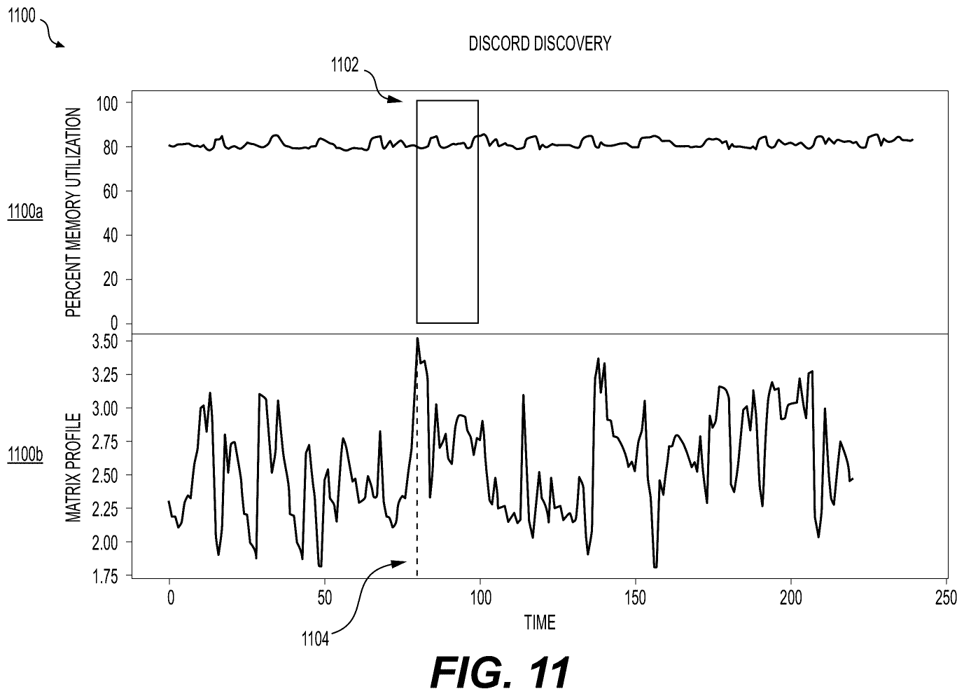

FIG. 11 depicts graphs of percent memory utilization and matrix profile implemented by the system herein, according to one or more embodiments. Discord discovery window 1100 may include graph 1100a, matrix profile 1100b, indication 1102, and indication 1104. Graph 1100a may depict percent memory utilization for one or more computers, which may be a measure of the percentage of RAM that is being used to store programs or data in memory. Matrix profile 1100b may be the corresponding matrix profile for graph 1100a or for one or more computers or subsystems. Indication 1102 may indicate a portion of graph 1100a. Indication 1104 may indicate a portion of matrix profile 1100b. Each time unit of graph 1100a or matrix profile 1100b may be a time unit corresponding to seconds, minutes, hours, or days, which may depend on values presented or data collected.

Discord discovery window 1100, graph 1100a, indication 1102, matrix profile 1100b, indication 1104 may indicate normal RAM usage. For example, graph 1100a may indicate a computer or subsystem with a healthy ram utilization. If RAM reaches 100% this computer may throttle, but graph 1100a may indicate it hovers at a healthy rate of around 80%. Discord discovery window 1100 along with graph 1100a and matrix profile 1100b may indicate that none of the subsequences generate visually significant matrix profiles that are different from any others.

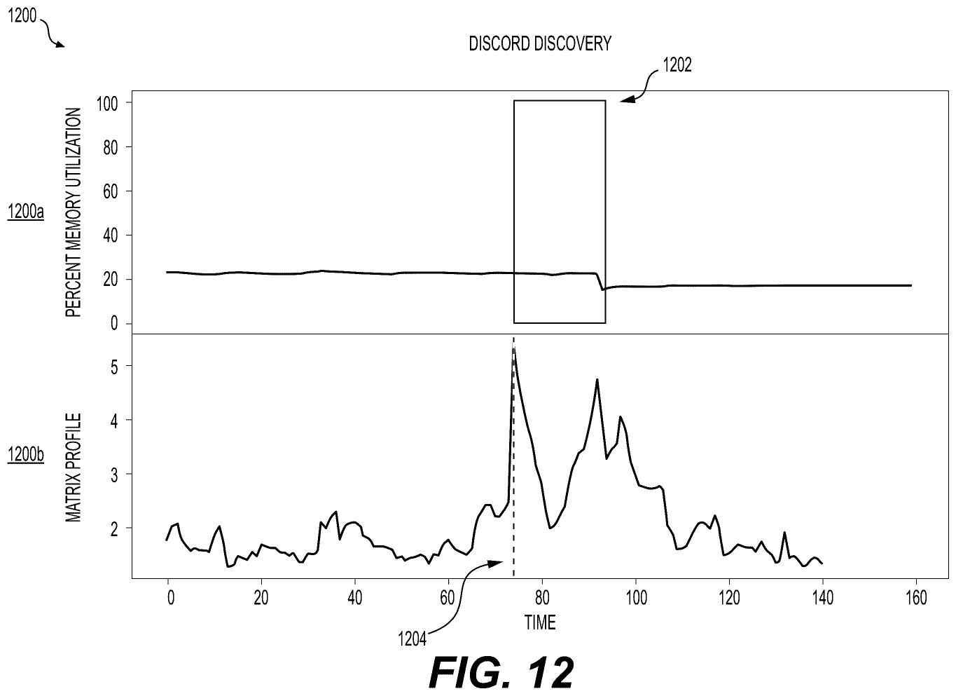

FIG. 12 depicts graphs of percent memory utilization and matrix profile implemented by the system herein, according to one or more embodiments.

Discord discovery window 1200 may include graph 1200a, matrix profile 1200b, indication 1202, and indication 1204. Graph 1200a may depict percent memory utilization for one or more computers, which may be a measure of the percentage of RAM that is being used to store programs or data in memory. Matrix profile 1200b may be the corresponding matrix profile for graph 1200a or for one or more computers or subsystems. Indication 1202 may indicate a portion of graph 1200a. Indication 1204 may indicate a portion of matrix profile 1200b. Each time unit of graph 1200a or matrix profile 1200b may be a time unit corresponding to seconds, minutes, hours, or days, which may depend on values presented or data collected.

Discord discovery window 1200, graph 1200a, indication 1202, matrix profile 1200b, and indication 1204 may indicate an instance where matrix profile 1200b discovers anomalous RAM usage that warrants further investigation. For example, matrix profile 1200b may indicate where the matrix profile has picked up an interesting anomaly. Discord discovery window 1200 may indicate that the system was continuously running at 22% ram when at around time 90 or after the time of indication 1204, it drops permanently down to 17% (for example, indication 1202). Thus, this may warrant further investigation, as seen by indication 1204 and matrix profile 1200b, along with graph 1200a and indication 1202, which may indicate that important process had failed and is now no longer running, thus causing the sudden drop in RAM.

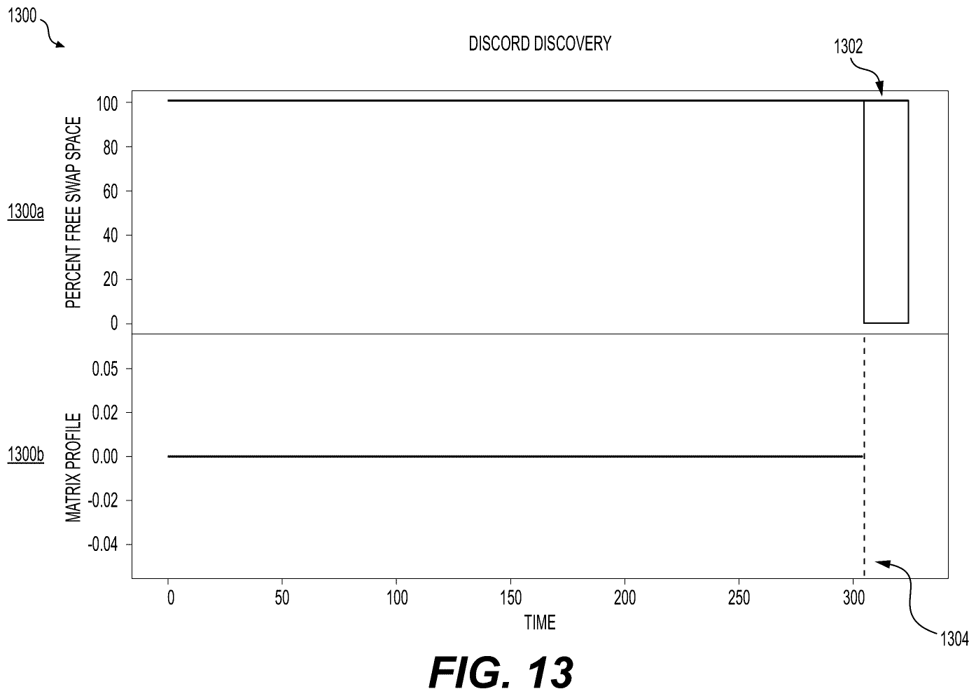

FIG. 13 depicts graphs of percent free swap and matrix profile implemented by the system herein, according to one or more embodiments.

Discord discovery window 1300 may include graph 1300a, matrix profile 1300b, indication 1302, and indication 1304. Graph 1300a may depict percent free swap for one or more computers or systems, which may be refer to percentage of the swap space that is currently not being used. For example, swap space may be a designated of hard drive (or storage disk) that the operating system can use as an overflow for RAM when the physical RAM is fully utilized. If this number drops below 100, it may indicate that the computer is low on RAM and is now using hard disk for RAM operations which may be much slower. Matrix profile 1300b may be the corresponding matrix profile for graph 1300a or for one or more computers or subsystems. Indication 1302 may indicate a portion of graph 1300a. Indication 1304 may indicate a portion of matrix profile 1300b. Each time unit of graph 1300a or matrix profile 1300b may be a time unit corresponding to seconds, minutes, hours, or days, which may depend on values presented or data collected.

Discord discovery window 1300 may indicate a perfectly healthy computer's percent free swap. For example, graph 1300a and indication 1302 may indicate that this computer has never once dug into the swap space, and may indicate that its RAM has always been sufficient for all its operations. Correspondingly, matrix profile 1300b and indication 1304 may indicate that no Matrix Profile anomalies have been reported.

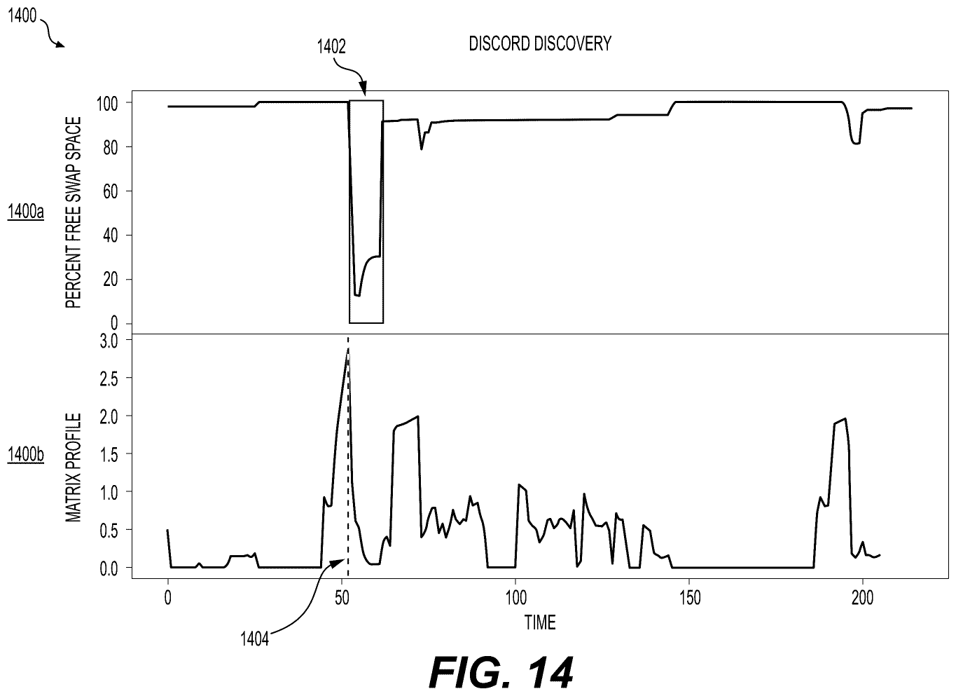

FIG. 14 depicts graphs of percent free swap and matrix profile implemented by the system herein, according to one or more embodiments. Discord discovery window 1400 may include graph 1400a, matrix profile 1400b, indication 1402, and indication 1404. Graph 1400a may depict percent free swap for one or more computers or systems, which may be refer to percentage of the swap space that is currently not being used. Matrix profile 1400b may be the corresponding matrix profile for graph 1400a or for one or more computers or subsystems. Indication 1402 may indicate a portion of graph 1400a. Indication 1404 may indicate a portion of matrix profile 1400b. Each time unit of graph 1400a or matrix profile 1400b may be a time unit corresponding to seconds, minutes, hours, or days, which may depend on values presented or data collected.

Discord discovery window 1400 may indicate a computer or system's percent free swap that indicates the computer or system may need further investigation. For example, graph 1400a and indication 1402 indicate that this computer or system may start out healthy at 100% swap space and then it may indicate that the computer or system experiences a drastic drop. The corresponding matrix profile 1400b anomaly detection may be able to detect this with a prominent peak in the matrix profile coupled with the drastic drop in percent free swap, which may also be seen by indication 404, and further may indicate that this computer warrants further investigation as to what caused this in order to ensure it does not happen again.

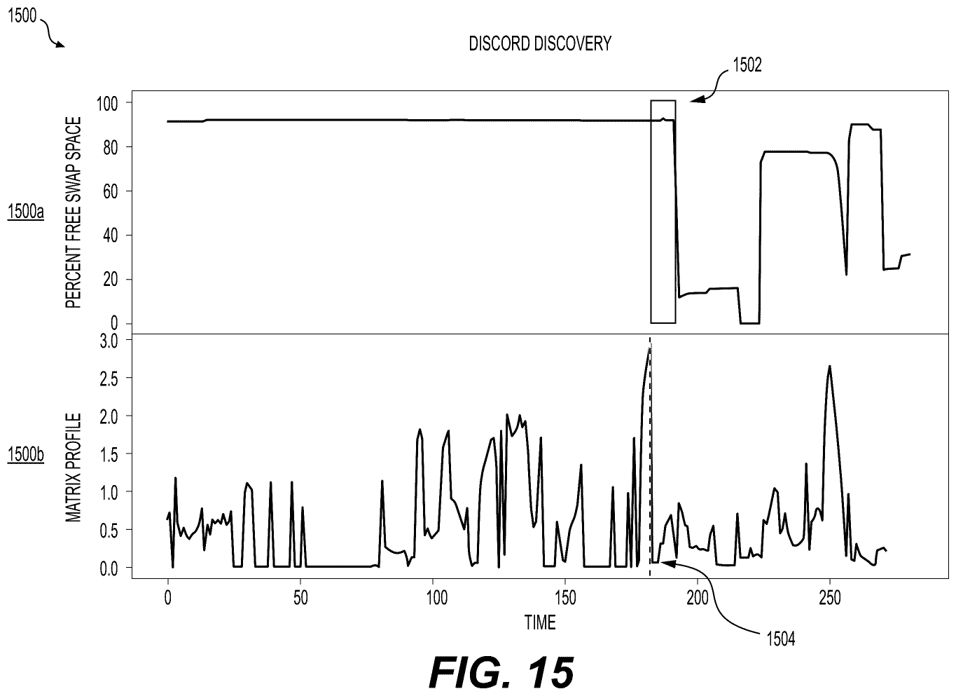

FIG. 15 depicts graphs of percent free swap and matrix profile implemented by the system herein, according to one or more embodiments.

Discord discovery window 1500 may include graph 1500a, matrix profile 1500b, indication 1502, and indication 1504. Graph 1500a may depict percent free swap for one or more computers or systems, which may be refer to percentage of the swap space that is currently not being used. Matrix profile 1500b may be the corresponding matrix profile for graph 1500a or for one or more computers or subsystems. Indication 1502 may indicate a portion of graph 1500a. Indication 1504 may indicate a portion of matrix profile 1500b. Each time unit of graph 1500a or matrix profile 1500b may be a time unit corresponding to seconds, minutes, hours, or days, which may depend on values presented or data collected.

Discord discovery window 1500 may indicate a computer's percent free swap that indicates it may need further intervention. For example, graph 1500a and indication 1502 may indicate that a specific computer or system has been using swap space since the beginning, which may be a negative indication already, however even if a computer or system has been using swap space since the beginning the computer may still run, just more slowly. The matrix profile 1500b successfully picks up a steep drop in swap space, which may also be seen at indication 1504, which when swap space runs out, the computer or system may experience sever degradation. Thus, discord discovery window 1500, graph 1500a, indication 1502, matrix profile 1500b, and indication 1504 may indicate or signify that this computer or system will require intervention, which may include immediate intervention. One or more embodiments may include real-time results for a user or system that allows for immediate intervention in systems or computers that would otherwise be permanently damaged by analysis shortly or long after the anomaly or discord occurs.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for processing live streaming data, the method comprising:
creating, for a stream of data, a matrix profile from one or more parameters of a system, the creating including:
identifying a set of subsequences from the stream of data;
computing a distance profile for each subsequence of the set of subsequences, wherein the distance profile includes a calculated distance between a particular subsequence and each other subsequence of the set of subsequences;
identifying a minimum calculated distance for each subsequence from the set of subsequences; and
determining a matrix profile that includes one or more minimum calculated distances for each subsequence from the set of subsequences, the matrix profile being a vector;
identifying a first state for a first interval of the stream of data based on a comparison of the one or more minimum calculated distances from the matrix profile being below a threshold value over a span of time; and
identifying a second state for a second interval of the stream of data based on a comparison of the one or more minimum calculated distances from the matrix profile being above the threshold value over a span of time.

2. The method of claim 1, further comprising identifying one or more potential discords in the stream of data based on values of one or more of the matrix profiles being above a first threshold value,
wherein the first state is a state indicating that the system is functioning between predetermined upper and lower bounds for the one or more parameters based on the values of the matrix profile being below the threshold value over a first span of time.

3. The method of claim 1, further comprising identifying one or more potential discords in the stream of data based on values of one or more of the matrix profiles being above a first threshold value,
wherein the second state is a state indicating that the system requires further investigation for the one or more parameters based on the values of the matrix profile being above the threshold value over a second span of time.

4. The method of claim 1, further comprising identifying one or more potential discords in the stream of data based on values of one or more of the matrix profiles being above a first threshold value,
wherein the second state is a state indicating that the system requires intervention for the one or more parameters based on the values of the matrix profile being above the threshold value over a second span of time.

5. The method of claim 1, further comprising:
processing the stream of data from one or more devices using a real time anomaly streaming module by producing a stream of granular data based on the one or more parameters from the one or more devices, wherein the data is a time series of data.

6. The method of claim 1, wherein the one or more parameters of the system includes central processing unit load.

7. The method of claim 1, wherein the one or more parameters of the system includes percent input output wait.

8. The method of claim 1, wherein the one or more parameters of the system includes percent central processing unit utilization.

9. The method of claim 1, wherein the one or more parameters of the system includes percent memory utilization.

10. The method of claim 1, wherein the one or more parameters of the system includes percent free swap.

11. The method of claim 1, wherein at least one of the identifying the first state or the identifying the second state further comprises processing live streaming data for thousands of systems simultaneously.

12. The method of claim 1, further comprising utilizing a sliding window approach to extract all possible subsequences of a particular length from the stream of data to create the matrix profile.

13. The method of claim 1, wherein the calculated distance between the particular subsequence and each other subsequences from the set of subsequences comprises applying a Euclidean distance calculation to create the matrix profile.

14. A computer-implemented method for processing live streaming data, the method comprising:
monitoring data from a computer device using a programming interface with a unified stream-processing framework,
wherein the data corresponds to one or more parameters of the computer device;
creating a matrix profile for the data;
identifying a healthy state based on a first threshold value of the matrix profile over a span of time;
identifying an investigation state based on a second threshold value of the matrix profile over the span of time;
identifying an intervention state based on a third threshold value of the matrix profile over the span of time; and
outputting an alert based on the identifying of the investigation state or the identifying of the intervention state.

15. The method of claim 14, wherein the one or more parameters of the computer device includes central processing unit load.

16. The method of claim 14, wherein the one or more parameters of the computer device includes percent input output wait.

17. The method of claim 14, wherein the one or more parameters of the computer device includes percent central processing unit utilization.

18. The method of claim 14, wherein the one or more parameters of the computer device includes percent memory utilization.

19. The method of claim 14, wherein the one or more parameters of the computer device includes percent free swap.

20. A system for determining group-level anomalies for information technology events, the system comprising:
a memory having processor-readable instructions stored therein; and
at least one processor configured to access the memory and execute the processor-readable instructions to perform operations including:
creating for a stream of data, a matrix profile from one or more parameters of a system, the creating including:
identifying a set of subsequences from the stream of data;
computing a distance profile for each subsequence of the set of subsequences, wherein the distance profile includes a calculated distance between a particular subsequence and each other subsequence of the set of subsequences;
identifying a minimum calculated distance for each subsequence from the set of subsequences; and
determining a matrix profile that includes one or more minimum calculated distances for each subsequence from the set of subsequences, the matrix profile being a vector;
identifying a first state for a first interval of the stream of data based on a comparison of the one or more minimum calculated distances from the matrix profile being below a threshold value over a span of time; and
identifying a second state for a second interval of the stream of data based on a comparison of the one or more minimum calculated distances from the matrix profile being above the threshold value over a span of time.
